(19) United States
(12) Patent Application Publication
(10) Pub. No.: US 2007/0067517 A1
(43) Pub. Date: Mar. 22, 2007

(54) INTEGRATED PHYSICS ENGINE AND RELATED GRAPHICS PROCESSING SYSTEM

(76) Inventor: Tzu-Jen Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/162,788

(22) Filed: Sep. 22, 2005

(51) Int. Cl. G06F 13/00

(52) U.S. Cl. 710/100

(57) ABSTRACT

Motherboards and graphics processing systems incorporating an integrated physics engine are disclosed. A proposed motherboard includes an integrated physics engine (IPE) including a north bridge circuit and a physics computing circuit; and a south bridge circuit coupled to the north bridge circuit.

### BACKGROUND OF THE INVENTION

1. Field of the Invention

The present invention relates to the computer system, and more particularly, to a motherboard and a graphics processing system equipped with an integrated physics engine and related method.

2. Description of the Prior Art

In conventional computer systems, the central processing unit (CPU) executes specially designated software to take charge of every aspect of the graphics processing operations. Since all of the graphics computing was conducted by the CPU, graphics-intensive applications often cause sluggishness and degraded system performance.

The advent of the graphics processing unit (GPU) reduced the rendering load of the CPU in most graphics processing applications. As is well known in the art, the GPU is deployed to take charge of 3D setup and rendering functions that were previously performed by the CPU so that the CPU is able to handle other duties, such as the physics operations, more efficiently.

However, as graphics content expanded in scale and scope, the workload of the physics operations needs to be performed by the CPU increased dramatically thereby resulting in many classes of physics simulation cannot be performed in real time.

### SUMMARY OF THE INVENTION

According to one aspect of the invention, a motherboard is disclosed comprising: an integrated physics engine (IPE) including a north bridge circuit and a physics computing circuit; and a south bridge circuit coupled to the north bridge circuit.

According to another aspect of the invention, a graphics processing system is disclosed comprising: an integrated physics engine (IPE) including a first north bridge circuit and a physics computing circuit; and a graphics processing circuit coupled to the first north bridge circuit.

According to another aspect of the invention, an integrated physics engine (IPE) is disclosed comprising: a bus interface; a physics computing circuit for performing physics operations; and a north bridge circuit coupled to the bus interface and the physics computing circuit.

A method for performing physics operations is also disclosed comprising: providing a graphics processing circuit capable of performing matrix operations; setting the device identification of the graphics processing circuit as a PCI device other than the display controller; and utilizing the graphics processing circuit to perform the physics operations.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of a computer system according to an exemplary embodiment of the present invention.

FIGS. 2 through 4 are simplified block diagrams of a motherboard of FIG. 1 according to different embodiments of the present invention.

### DETAILED DESCRIPTION

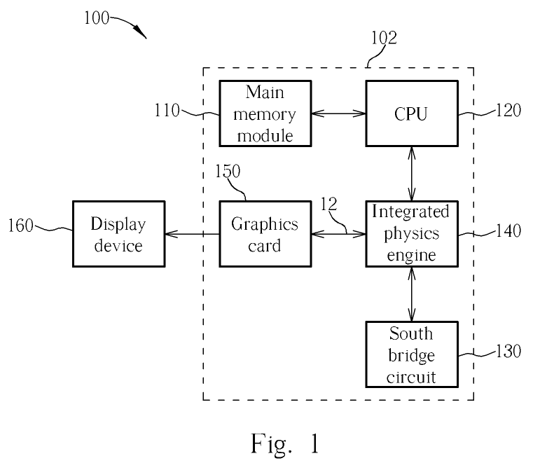

Please refer to FIG. 1, which shows a simplified block diagram of a computer system 100 according to an exemplary embodiment of the present invention. The computer system 100 comprises a main memory module 110, a CPU 120, a south bridge circuit 130, an integrated physics engine (IPE) 140, a graphics card 150, and a display device 160. Note that the term “integrated physics engine” as used herein encompasses any single chip or processor that integrates at least the functionalities of north bridge and physics operations. In general, the physics operations involve collision detection, soft or rigid body dynamics, particle system simulation, cloth simulation, fluid simulation, or other physics simulations and accelerations.

The main memory module 110 is installed on at least one memory slot of a motherboard 102 of the computer system 100. The CPU 120 is typically installed on a CPU socket of the motherboard 102. The graphics card 150 is inserted into an appropriately configured slot of the motherboard 102, such as an AGP slot or a PCI-E slot. In this embodiment, the south bridge circuit 130 and the IPE 140 are positioned on the motherboard 102. As shown in FIG. 1, the graphics card 150 is coupled to the IPE 140 through a bus 12 mounted on the motherboard 102. In the computer system 100, visual output is provided on the display device 160 operating under the control of the graphics card 150. The display device 160 may be a conventional CRT monitor, a LCD monitor, or any other visual output device.

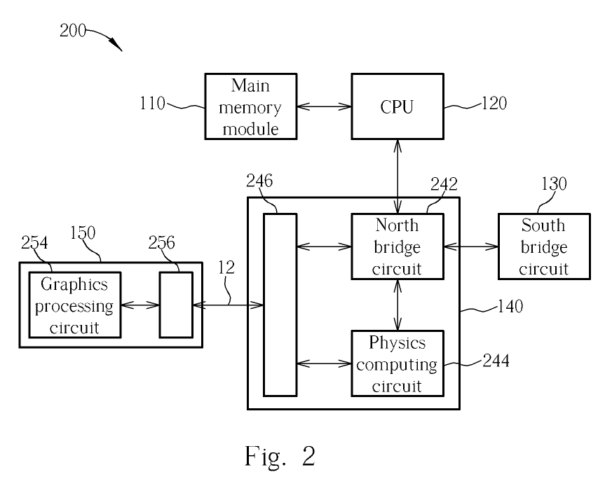

FIG. 2 shows a simplified block diagram of a motherboard 200 being a first embodiment of the motherboard 102. As shown, the IPE 140 comprises a north bridge circuit 242 for bridging the CPU 120 and the south bridge circuit 130; a physics computing circuit 244 coupled to the north bridge circuit 242; and a bus interface 246 coupled to the north bridge circuit 242 and the physics computing circuit 244. The bus interface 246 may comprise an AGP bus interface, a PCI-E bus interface, or both. The physics computing circuit 244 is arranged for performing physics operations in order to share the computations of physics operations needed to be performed by the CPU 120. The physics computing circuit 244 may be implemented with any hardware architecture that can perform matrix computations to improve the computing speed of the physics operations. The graphics card 150 comprises a graphics processing circuit 254 for performing graphics rendering operations; and a bus interface 256 coupled to the graphics processing circuit 254 and the bus interface 246 for intercommunicating the graphics processing circuit 254 and the IPE 140. Generally, the graphics rendering operations performed by the graphics processing circuit 254 involve 2D rendering and 3D rendering, but this is merely an example rather than a restriction of the practical applications.

In this embodiment, the bus 12 is implemented with a high-speed bus with sufficient bandwidth for communicating between the IPE 140 and the graphics card 150. For example, the bus 12 may be a PCI-E bus while both the bus interfaces 246 and 256 are PCI-E bus interfaces. Thereto, the bus 12 may be an AGP bus while both the bus interfaces 246 and 256 are AGP bus interfaces. In practice, other high-speed bus and associated bus interfaces may be employed to interconnect the IPE 140 and the graphics card 150. Additionally, the CPU 120 of this embodiment comprises a memory controller (not shown) for controlling data accessing of the main memory module 110. The IPE 140 may access the main memory module 110 through a unified memory architecture (UMA) while performing the physics operations. Alternatively, a dedicated memory (not shown) for the IPE 140 may be arranged on the motherboard 102.

In operations, the CPU 120 issues commands to request the physics computing circuit 244 to perform required physics operations, and the physics computing circuit 244 returns computing results, such as coordinates of image objects, to the CPU 120 through the north bridge circuit 242. Subsequently, the CPU 120 transmits the computing results of the physics computing circuit 244 to the graphics processing circuit 254 through the north bridge circuit 242 so that the graphics processing circuit 254 obtains related information of image object to be rendered, such as the location information or other physics simulation results of the image object. In one aspect, the cooperation of the IPE 140 and the graphics processing circuit 254 implements a graphics processing system of the computer system 100.

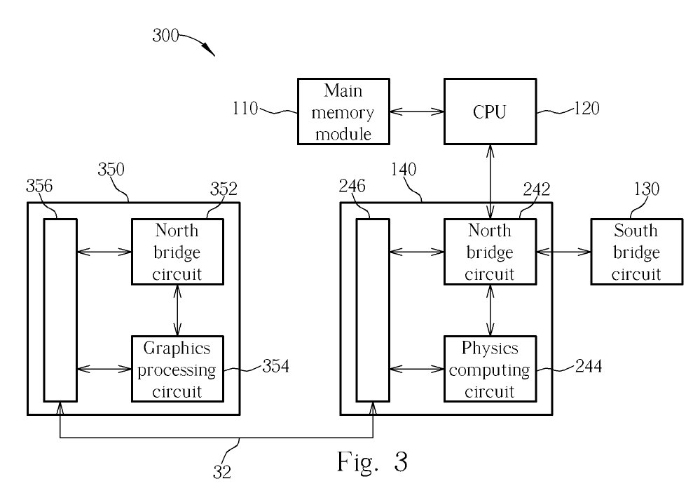

Please refer to FIG. 3, which shows a simplified block diagram of a motherboard 300 being a second embodiment of the motherboard 102. In the motherboard 300, an integrated graphics processor (IGP) 350 is arranged to replace the functionalities of the graphics card 150 described previously. Note that the term “integrated graphics processor” as used herein encompasses any single chip or processor that integrates at least the functionalities of north bridge and graphics processing. As shown in FIG. 3, the IGP 350 comprises a north bridge circuit 352, a graphics processing circuit 354, and a bus interface 356. The graphics processing circuit 354 is employed for performing graphics rendering operations. The bus interface 356 is employed for intercommunicating the graphics processing circuit 354 and the bus interface 246 of the IPE 140 through a bus 32 mounted on the motherboard 300. The bus 32 may be a PCI-E bus while both the bus interfaces 246 and 356 are PCI-E bus interfaces. Thereto, the bus 32 may be an AGP bus while both the bus interfaces 246 and 356 are AGP bus interfaces. In practice, other high-speed bus and associated bus interfaces may be employed to interconnect the graphics processing circuits 354 and the IPE 140.

In this embodiment, the visual output is controlled by the graphics processing circuit 354 of the IGP 350. The north bridge circuit 352 of the IGP 350 may not be utilized and, therefore, can be disabled or turned off when it is not in use.

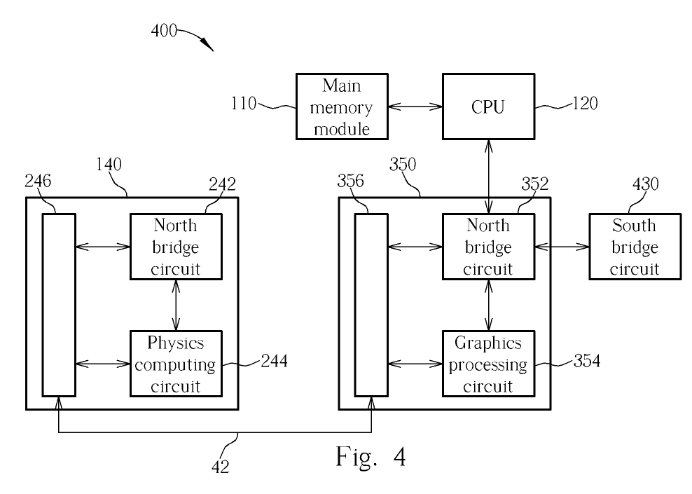

FIG. 4 shows a simplified block diagram of a motherboard 400 being a third embodiment of the motherboard 102. In the motherboard 400, the IPE 140 and the IGP 350 are mutually coupled through a high-speed bus 42, but the positions of the IPE 140 and the IGP 350 are swapped with respect to the motherboard 300 shown in FIG. 3. In such a configuration, the CPU 120 and a south bridge circuit 430 are bridged through the north bridge circuit 352 of the IGP 350 rather than the north bridge circuit 242 of the IPE 140. As a result, the north bridge circuit 242 of the IPE 140 may not be utilized and, therefore, can be disabled or turned off when it is not in use.

As in the foregoing descriptions, the physics computing circuit 244 can be implemented with any hardware architecture that can perform matrix computations. For example, the physics computing circuit 244 may be implemented with the 3D engine of a typical graphics processing circuit. Specifically, the system designer can utilize a programmable shader of the typical graphics processing circuit, such as the pixel shader, as the physics computing circuit 244. To achieve this, the device identification of the graphics processing circuit to be used as the physics computing circuit 244 can be set to a configuration differing from the device identification of the graphics processing circuit 254 through a hardware/software strapping means. For example, according to the Appendix D of PCI Local Bus Specification 2.2 or 2.3, the device identification of the graphics processing circuit 254 or 354 is set as a display controller, i.e., the Base Class of Class codes of the PCI configuration register of the graphics processing circuit 254 or 354 is 03h. The device identification of the graphics processing circuit to be used as the physics computing circuit 244 can be set as a PCI device other than the display controller. For example, the device identification of the graphics processing circuit to be used as the physics computing circuit 244 may be set as a multimedia device. This can be achieved by setting the Base Class of Class codes of the graphics processing circuit to be used as the physics computing circuit 244 to 04h corresponding to the multimedia device through either a hardware strapping pin or software control. In this embodiment, the Sub-Class of Class codes of the graphics processing circuit may be set to 80h corresponding to “other multimedia device”, but this is merely an example rather than a restriction of the present invention. By this way, the graphics processing circuit to be used as the physics computing circuit 244 is recognized as a multimedia device rather than a display controller when the computer system 100 starts-up (i.e., boots up). Subsequently, the operating system of the computer system 100 loads a predetermined driver into the graphics processing circuit so that the graphics processing circuit functions as a physics computing circuit rather than a graphics processing circuit.

In practice, the device identification of the graphics processing circuit to be used as the physics computing circuit 244 may be set as a PCI device of other type, such as “device was built before Class Code definitions were finalized”, “processors”, “device does not fit in any defined classes”, etc. For example, the Base Class and Sub-Class of Class codes of the graphics processing circuit can be respectively set to 0Bh and 40h so that the graphics processing circuit is recognized as a co-processor by the operating system of the computer system 100.

In addition, the IPE 140 and the IGP 350 can be designed to have identical hardware structures but different device identification settings to further reduce the manufacturing cost per unit.

In another embodiment, the north bridge circuit 242 of the IPE 140 also comprises a memory controller (not shown), and the physics computing circuit 244 may access a main memory module of the computer system through the memory controller of the north bridge circuit 242.

As in the aforementioned descriptions, it can be appreciated that the disclosed motherboards with the IPE are feasible for use in Intel P4 platforms, AMD K8 platforms, and various multi-CPU computer systems.

Those skilled in the art will readily observe that numerous modifications and alterations of the device and method may be made while retaining the teachings of the invention. Accordingly, the above disclosure should be construed as limited only by the metes and bounds of the appended claims.

1. A motherboard comprising:
an integrated physics engine (IPE) including a north bridge circuit and a physics computing circuit; and
a south bridge circuit coupled to the north bridge circuit.

2. The motherboard of claim 1, wherein the physics computing circuit is utilized for performing physics operations.

3. The motherboard of claim 1, further comprising:
at least one memory slot, for installing a main memory module; and
a CPU socket for installing a CPU having a memory controller for controlling data accessing of the main memory module;
wherein the north bridge circuit bridges the CPU socket and the south bridge circuit.

4. The motherboard of claim 1, further comprising:
at least one memory slot for installing a main memory module; and
at least one CPU socket, each for installing a CPU;
wherein the north bridge circuit bridges the CPU socket, the memory slot, and the south bridge circuit.

5. The motherboard of claim 1, wherein the physics computing circuit is a graphics processing circuit whose device identification is set as a PCI device exclusive of the display controller.

6. The motherboard of claim 1, wherein the physics computing circuit is a 3D engine of a graphics processing circuit whose device identification is set as a PCI device other than the display controller.

7. The motherboard of claim 1, wherein the physics computing circuit is a programmable shader of a graphics processing circuit whose device identification is set as a PCI device other than the display controller.

8. A graphics processing system comprising:
an integrated physics engine (IPE) including a first north bridge circuit and a physics computing circuit; and
a graphics processing circuit coupled to the first north bridge circuit.

9. The graphics processing system of claim 8, wherein the physics computing circuit is utilized for performing physics operations.

10. The graphics processing system of claim 8, wherein the graphic processing circuit couples to the first north bridge circuit through a PCI-Express bus or an AGP bus.

11. The graphics processing system of claim 8, wherein the physics computing circuit is a graphics processing circuit whose device identification is set as a PCI device other than the display controller.

12. The graphics processing system of claim 8, wherein the physics computing circuit is a 3D engine of a graphics processing circuit whose device identification is set as a PCI device other than the display controller.

13. The graphics processing system of claim 8, wherein the physics computing circuit is a programmable shader of a graphics processing circuit whose device identification is set as a PCI device other than the 3D controller.

14. The graphics processing system of claim 8, wherein the graphics processing circuit is positioned on a graphics card coupled to the IPE.

15. The graphics processing system of claim 8, wherein the graphics processing circuit is integrated within an integrated graphics processor (IGP) coupled to the IPE, and the IGP includes the graphics processing circuit and a second north bridge circuit.

16. The graphics processing system of claim 8, wherein the computing result of the physics computing circuit is transmitted to the graphics processing circuit through a CPU.

17. An integrated physics engine comprising:
a bus interface;
a physics computing circuit for performing physics operations; and
a north bridge circuit coupled to the bus interface and the physics computing circuit.

18. The integrated physics engine of claim 17 is a single chip.

19. The integrated physics engine of claim 17, wherein the bus interface comprises a PCI-Express bus interface, an AGP bus interface, or both.

20. The integrated physics engine of claim 17, wherein the physics computing circuit accesses a memory module through a memory controller of a CPU while performing the physics operations.

21. The integrated physics engine of claim 17, wherein the north bridge circuit comprises a memory controller, and the physics computing circuit accesses a memory module through the memory controller while performing the physics operations.

22. The integrated physics engine of claim 17, wherein the physics computing circuit is a graphics processing circuit whose device identification is set as a PCI device other than the display controller.

23. The integrated physics engine of claim 17, wherein the physics computing circuit is a 3D engine of a graphics processing circuit whose device identification is set as a PCI device other than the display controller.

24. The integrated physics engine of claim 17, wherein the physics computing circuit is a programmable shader of a graphics processing circuit whose device identification is set as a PCI device other than the display controller.

25. A method for performing physics operations, comprising:
providing a graphics processing circuit capable of performing matrix computations;
setting the device identification of the graphics processing circuit as a PCI device other than the display controller; and
utilizing the graphics processing circuit to perform the physics operations.
